(19) United States
(12) Patent Application Publication
(10) Pub. No.: US 2012/0253824 A1
(43) Pub. Date: Oct. 4, 2012

(54) METHODS AND SYSTEM OF VOICE CONTROL

(75) Inventor: Magno Alcantara Talavera, Adolfo Lopez Mateos (MX)

(73) Assignee: MAGNO ALCANTARA TALAVERA, ADOLFO LOPEZ MATEOS (MX)

(21) Appl. No.: 13/500,059

(22) PCT Filed: Sep. 29, 2010
(86) PCT No.: PCT/MX10/00099

§ 371 Date: Jun. 20, 2012

(30) Foreign Application Priority Data
Oct. 8, 2009 (MX) MX/A/2009/010902

(51) Int. Cl. G10L 21/00

(52) U.S. Cl. 704/275; 704/E21.001

(57) ABSTRACT

This invention relates to a system with different modes of operation or performance that integrates all the key components for the control of most domestic services, such as telephone, lighting and audio/video system, through audio inputs such as words or phrases by a user.

The system includes a master unit that coordinates the total operation and communication with other technologies and/or with peripheral units. The system integrates a general output unit for controlling turning on and off of lights, motors, etc., an infrared unit for controlling audio and video system, a DAA unit for interaction with the Public Switched Telephone Network, a speaker phone unit, a serial communication port, a microphone, a speaker, among other accessories required for interaction with the user. The present invention also provides two methods which describe the operation of the system disclosed in this document, to increase functionality and versatility of this system compared to the prior art. One method is based on hierarchical sequences of audio inputs, such as a word or phrase, the other method is based on sound inputs, which work directly, i.e., without sequences, and similarly, in both cases, words or phrases that can be detected by the system are pre-recorded. Sound inputs are received through a microphone that is integrated into the system of the present invention.

The object of this invention is to create a system that integrates into a single standalone but extensible device, a set of different technological developments aimed at controlling the basic needs that are found in homes or offices, in order to meet the needs of people with some motion disabilities, since is fully governed by sound inputs.

### BACKGROUND OF INVENTION

Currently, most automation equipment controlled by voice inputs are systems dependent upon processors or computers which features and capabilities exceed and do not go hand in hand with the functions inherent to an electronic system to control domestic services where, for example, a disadvantage may be that the computer must be continuously turned on, in addition to the mandatory use of wireless microphone since, otherwise, a computer would be necessary in each room where desired operations are located, such that the system hears the orders of users. In addition, since they are devices (computers) designed for other purposes, many of such devices interact with domestic services only through a single electronic technology, such as infrared technology, radio frequency (RF), direct wiring (increasing the installation time, etc.)., as shown in the Publication US2008/0091432 A1, wherein an external auxiliary unit is commonly used for each operation to be performed, such as a light switch operation, resulting in a lack of flexibility in existing systems, and which in turn leads to the high costs of adding an interface, either by RF or other method, for each operation to be performed by voice. For example, if it is desired to turn on and off four lights, the same number of interfaces is needed to meet each operation, and this is due to the fact that the prior art is dependent on a technology which is compatible with the computer. In the same manner, in most cases, these systems have a limited control in relation to the devices and services that are encountered in a housing, since many of them controls simply, for example, lights, shutters and, sometimes, audio and video equipment, which causes a lack of complete control of domestic services, which is a disadvantage to the user. Also, in addition to the need of systems of the prior art, which must incorporate wireless microphones and interfaces for each operation to be performed, and the constraint that few domestic services are commonly controlled, the fact of maintaining a processor or computer turned constantly on generates a very high electrical power waste, which is detrimental to the service life of the system and to the environment. These systems rely on software designed to process audio and send orders to the outside through an interface of any electronic technology oriented to domestic services, where certain hardware units of the same technology are incorporated to the network, which perform such operations, in a manner either wired or wireless. However, as mentioned above, this approach of integration through a computer has technical problems generated from the adequacy of a computer (PC, laptop, tablet, etc.) to the control of existing services in a building.

In view of the disadvantages of the prior art, the present invention discloses a flexible system which has a greater capacity of operations and possesses an improved functionality as compared to other systems, since it does not depend totally on only one type of technology, is completely integrated to allow control of a wide variety of electronic operations oriented to more domestic services, in comparison to the prior art, and is also designed for easy installation, which allows that the system of the present application can be used by different market types, that is, from people who desire a voice control system for reasons of convenience, to people with mobility impairment that can be benefited greatly from the advantages of the present invention.

On the other hand, many of the existing systems of voice control, which are operated in processors or computers, use a vocabulary fairly large for the user that, in a normal conversation where the system is not required to act, causes that the computer identifies as orders certain words on the conversation and, thus, executes operations without user consent, which results in false detections and, in some cases, in the execution of operations no desired by the user, that in turn affects the user control on the various domestic services that are involved. Likewise, these false detections occur in voice systems that work with words or phrases that can be said, and whose operations are performed immediately, i.e., without any initial word or sequence, where if the environment is noisy or if the user holds a conversation that is within reach of the team, these false detections and, therefore, undesired operations, are caused. Depending on the type of system, it can cause the switching on of lights, changing of the channel on the TV, closing of the door, etc., when the user does not want it. In view of the drawbacks in the operation of systems in the prior art, the present invention also relates to a method of operation for a system in accordance with the present invention, based on sequences, which in turn reduces the risk of error due to false detections, and facilitates the performance of voice operations, as it allows the system to function with a limited or relatively small vocabulary, so that no functionality is lost, and also facilitates the control and use of each word of the vocabulary in the system, wherein, at the same time as already mentioned, the undesired operations caused by the false detections are avoided.

In view of the disadvantages of the systems and methods of existing techniques, the present invention utilizes an equipment designed to be easily installed at the place where it is desired to perform operations and directly and/or indirectly control most domestic services in a house, based on a microcontroller with voice recognition capabilities, in addition to various peripheral units fully integrated into the same system, which allows a greater flexibility to integrate the control of various services or domestic operations, as compared to systems of existing technology. Therefore, in order to eliminate the drawbacks mentioned above, the development of this system was devised, as well as two operating methods that interact within said system, thus providing the user, by means of voice, with integration of different technologies to control the services used in a home, through a functional and optimized manner. Said methods and system are intended to be protected by means of the present application.

### BRIEF DESCRIPTION OF FIGURES

Described below are embodiments of the invention with reference to the accompanying drawings, in which:

FIG. 1 shows an exemplified system, in accordance with the present application.

FIG. 2 shows an exemplified manner in which the sound inputs are grouped and must be said by each user, based on the voice commands, to support the methods disclosed and in accordance with the present invention.

FIG. 3A is a flow chart of the method that describes a type of functionality of the system, in accordance with the present application.

FIG. 3B is a flow chart that shows a particular embodiment of the method shown in FIG. 3A, in accordance with the present invention.

FIG. 3C is a flow chart that shows a particular embodiment of the method shown in FIG. 3A, in accordance with the present invention.

FIG. 3D is a flow chart that shows a particular embodiment of the method shown in FIG. 3A, in accordance with the present invention.

FIG. 4A is a diagram of the method that describes a type of functionality of the system, in accordance with the present invention.

FIG. 4B is a flow chart that shows a particular embodiment of the method shown in FIG. 4A, in accordance with the present invention.

FIG. 4C is a flow chart that shows a particular embodiment of the method shown in FIG. 4A, in accordance with the present invention.

FIG. 4D is a flow chart that shows a particular embodiment of the method shown in FIG. 4A, in accordance with the present invention.

FIG. 5 shows the exemplified communication of the system with another technology through a serial communication port, in accordance with the present invention.

### DETAILED DESCRIPTION OF THE INVENTION

The following terms are used throughout this description to enable understanding of the same, however, one skilled in the art will appreciate that these terms are not intended, in any way, to limit the scope of the present application.

Voice order or command: Input digital samples of sound or set of sounds (such as phrases or words) chosen by the user or entered directly from the initial configuration of firmware and which are recorded in a specific location in system memory in order to compare them with audio inputs said by a user to perform operations.

Operations: Any action taken by the device in response to a given sound input, such as changing of channel, calling by telephone, turning on of some light, sending of a code via the serial communication port, etc.

The system of the present invention is an electronic device that incorporates all key components for the control of electronic and electrical household devices, such as lighting, telephone, and audio/video system, through the recognition of voice command sequences pre-recorded in the same, on a single device and without the need of a computer. As mentioned above, the system disclosed in this application solves the problems of the voice control systems of the prior art by allowing the integral control of the various housing facilities such as power, telephone, etc., as well as audio and/or video devices, and also with the possibility of communication with other technologies to allow the extension of the functionality thereof. In the same manner, it solves the problem of those methods for controlling a voice control system of the prior art, by reducing the risks posed by false detections and, at the same time, adding promptness in performing operations.

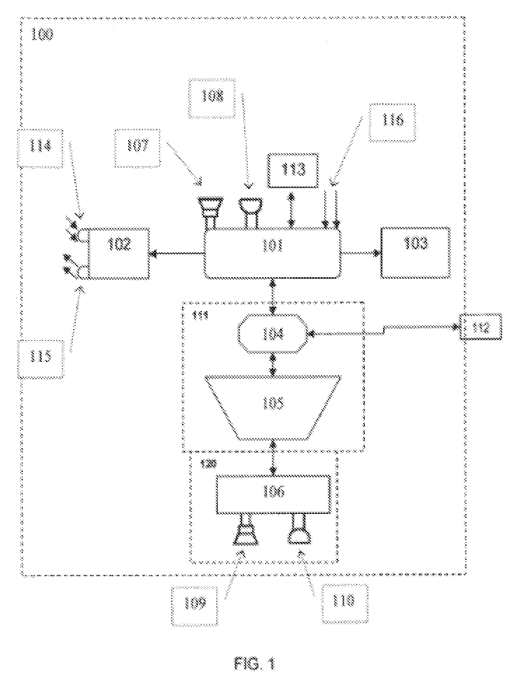

FIG. 1 shows the main parts and features of the system of the present invention. As shown in FIG. 1, the system 100 focuses on the master unit 101 that is connected and in communication with infrared peripheral unit 102, the general output peripheral unit 103, the serial communication port 113 and the peripheral unit of data access arrangement 111. All of these units contain all the ports and/or connections necessary for easy and rapid integration with domestic services, such as telephone, lighting, audio/video, etc. All peripherals are integrated within a single container cabinet specially designed for easy installation.

To achieve independence of operation, energy savings, ease of implementation and resource savings as compared to computer-based systems, the master unit 101 was devised using a microcontroller with capacity to synthesize, process and store audio inputs, and where this master unit 101 contains a plurality of channels of digital and analog inputs and outputs by which it can emit and/or receive pulses and/or information to communication with other units and/or communication standards, in addition to the ability to receive sound inputs, such as words or phrases, from each of a plurality of users, through a microphone 108 which is connected to said master unit 101 for processing, wherein said microphone can be replaced by a wireless microphone without affecting the scope of the present invention. Said sounds, which are received by the master unit 101, are synthesized and processed by said master unit 101 for a later comparison with digital samples of previously recorded audio inputs into the system, which will be termed as commands or orders. Said record of such samples of sound inputs or commands can be performed previously from the initial configuration of the system firmware, or by entering each word or phrase through the microphone 108 by the same user, so that the system makes a record of each of such words or phrases.

Once the system compares the audio inputs to sound samples or commands previously recorded, and if these received audio inputs substantially coincide with the samples recorded in the system, an operation is performed as a response by the peripheral units 102, 103, 111 and/or 113 directly connected to the master unit 101. The system interacts and gives reports to the user by means of audible signals through a speaker 107 which is connected directly to the master unit 101.

In addition to the communication with the peripheral units, the master unit 101 can communicate with other systems or technologies and manage operations through a serial communication port 113 which is connected directly to the master unit 101, using a serial communication standard such as the standard RS232, so that the capacity of the system 100 can be notoriously extended by allowing communication with other technologies such as UPB, X10, ZIGBEE, Z-WAVE, KNX, etc.

The infrared peripheral unit 102, connected directly to the master unit 101, has the capacity to receive through an infrared receiver 114, which converts the infrared code information in digital pulses or information that can be read by the master unit 101, such as, for example, the Vishay IR receiver or some other similar receptor, and memorize a large amount of infrared protocols of remote controls from different devices which are controlled by infrared signal, such as any TV, audio system, DVD, etc., and then perform the operation of transmitting them through an infrared LED 115 when a voice command is detected, which was previously associated with that operation, so that a plurality of system commands can be related with the operations performed by this infrared peripheral unit 102 and thereby control any equipment compatible with infrared protocols. This infrared peripheral unit 102 stores the infrared code related to a particular function by a remote control button to be memorized in a specific location previously chosen by the user, and then emits the same code each time the master unit receives or detects the corresponding voice order or command by at least one of a plurality of users. In other words, the infrared peripheral unit 102 is responsible for recording the information of each button on any remote control that operates through infrared network, and which is to be transmitted when a corresponding voice command is detected, so that when the system receives a related order by the master control, this information is emitted at the same frequency with which it was stored, and in an infrared form, to control the corresponding audio and/or video device. Depending on the configuration given to the system, the emission of such infrared signals or codes can be performed individually or sequentially, wherein said operation, which will be termed as “macros”, consists on emit a variable plurality of infrared codes defined previously so that a sequence of several consecutive infrared codes is emitted for the purpose of controlling a plurality of functions of a single compatible electronic device, and/or a plurality of compatible electronic devices, and wherein the plurality of infrared codes to be sent will depend on the previous configuration of the system. Said operation of macros can be stopped at any moment while executing if the system detects a corresponding voice command. To illustrate the operation of said infrared peripheral unit 102, if the infrared code of the remote control button to turn on a television is stored in the system at a previously determined memory location and also configures the system in order to send the code only once, whenever the user says the voice command or command sequence that invokes that location or operation, then the master unit 101 will give the order to the infrared peripheral unit 102 to emit, only once, the code that turns on the TV, allowing thus that said operation is performed when requested by the user.

The general output peripheral unit 103 is an amplifier phase for each of the at least one of the plurality of available channels in the master unit, which results in that one or more lamps motors, actuators, power levelers and in general any electronic and/or electrical device can be connected directly to the outputs of this unit, and thus control virtually any of these devices or circuits when a corresponding voice command is detected. The amplifier phase can be performed with relays, triacs, diacs, transistors and/or any other combination of electronic components that allows the power amplification for the control of devices operating on alternating current and/or direct current. Said general output peripheral unit 103 comprises a plurality of outlets 103A (not shown in the Figures). Each of the outputs 103A of this unit 103 has a default memory location from the initial configuration of the system firmware, so that every time the voice command that invokes that location or operation is detected, the master unit 101 will give the order to the general output peripheral unit 103 to change its status, either from 1 (ON) to 0 (OFF) or vice versa. This unit allows for the possibility to turn on and/or off one or more lights or actuators. These actuators can be implemented in motors, pumps, valves, switches, etc., or for controlling the opening and/or closing of shutters, windows, doors, curtains, and/or controlling the fluid flow (water, gas, etc.), etc. Also, said general output unit 103 allows for the addition, to at least one of the plurality of outputs, of a power leveler that works by contact, for example, in order to control lights, the chip HT7700 can be used to adjust the lighting level of each light bulb or bulbs up to the level desired by the user when a voice command is detected. Using the power levelers, the illumination level can be controlled using voice commands, however, one skilled in the art will appreciate that the scope of the present invention is not limited in any way by the use of the chip HT7700. Similarly, power levelers may be implemented for adjusting the power of various actuators and/or electrical and/or electronic devices, such as motors, pumps, valves and/or lights.

Each of the outputs 103A (not shown in the Figures) can be controlled individually or in groups by the master unit 101 when a corresponding voice command is detected.

Similarly, the user has the ability to combine or link the different operations of the plurality of peripheral units forming the system 100, thus forming groups, such that said relationship is stored in memory so that, by means of a voice command or command sequence, said group of operations can be performed. To facilitate the understanding of the present application, the relationship that forms groups of different operations involving several peripheral units will be termed as “scenarios”. The scenarios involve and combine a previously defined amount of operations of the plurality of peripheral units of the system 100, such as the infrared peripheral unit 102, the general output peripheral unit 103, the peripheral unit of data access arrangement 111 and/or serial communication port 113. For example, a scenario may be created by combining 5 different operations, through 2 peripheral units, which could be termed as scenario of “movie” where the system performs the operation, through infrared peripheral unit 102, for 1.—Turning on the TV, 2.—Turning on the DVD, 3.—Tuning the TV to the video channel, and then the system performs the operation, through the general output peripheral unit 103, for 4.—Lowering the shutters and, finally, 5.—Reducing the level of illumination of the bulbs up to a previously determined level, or the system can be configured such that the user stops leveling, and all the preceding using the corresponding voice commands. However, a great diversity of scenarios can be created with a wide variety of combinations of the functionalities of the peripheral units, which can be chosen by the user according to their desires and/or needs.

The system 100 has the ability to communicate with the Switched Telephone Network 112 (also named STN or Basic Telephone Network) commonly known as “telephone line” (known as Public Switched Telephone Network or PSTN). The interaction between the system 100 and the network 112 depends on the peripheral unit of data access arrangement DAA 111 (Data Access Arrangement for its acronym), which is an interface that allows transmission and reception of data between the system 100 and telephone network 112. This unit 111 is directly controlled by the master unit 101, so that it is possible to connect, disconnect, make or receive phone calls, etc., through the peripheral unit of data access arrangement DAA 111 when a corresponding voice command is detected. The peripheral unit DAA 111 is composed of a device DAA (Data Access Arrangement) 104 which acts as an interface between the master unit 101 with the PSTN 112 and also is complemented by an amplifier stage 105 for the interaction and compatibility with a speakerphone. By means of the device DAA 104, all the transmission of information is performed, such as voice, multi-frequency of dual tone DTMF (Dual-Tone Multi-Frequency for its acronym), etc., between the system 100 and the PSTN 112. The master unit 101 is responsible for emitting the DTMF tones when the corresponding voice commands are detected, which are transmitted through the peripheral unit DAA 111 to establish communication with another person on the other side of the telephone network. For example, when the system detects (by a user) each corresponding voice command that representing each digit that integrates a phone number (Example: if the number is 24871600, the user must say the words “two”, “four”, “eight”, “seven”, “one”, “six”, “zero”, “zero”, as long as those words have been recorded as commands), the system stores said number in temporary memory, either to perform, upon receiving a corresponding voice command, the operation for storing said number in the system memory for later use, and where a plurality of telephone numbers can be stored in the memory of the system for each user, or to perform, upon receiving the corresponding voice command, the operation for immediately calling or initiating a telephone call by converting each digit in the corresponding DTMF tone to transmit it over the switched telephone network and initiate the connection. When a user stores a phone number in memory, the system reports the location of where that phone number was stored by means of audible signals through the speaker 107, so that the user can initiate a phone call using any phone number stored in memory just saying the words or phrases that match the voice command representing the number of the location where the phone number is stored, that is, the user can choose, by means of any corresponding voice command, from among a plurality of phone numbers stored in memory and, by means of other corresponding voice command, the connection or telephone call is initiated by converting each digit of the stored number to their respective DTMF tone and, then, send said tones through the PSTN using the peripheral unit of data access arrangement DAA 111. Other operations that can be performed through voice commands using said peripheral unit of data access arrangement DAA 111 are connecting to or disconnecting from the PSTN, dialing the last dialed number (function commonly known as “redial”) reporting, through audible signals, the telephone number that is being said or that has been selected, deleting from the memory a telephone number that has been saved and selected, and/or deleting the last digit of a phone number that has been said. All these operations are requested or invoked by the different types of voice orders or commands which will be explained below.

To facilitate the telephone communication of the user, to the system of the present invention 100 is integrated a telephone speaker device 120 using an amplifier stage 105 which improves and clean the transmission. The speakerphone 120 directly communicates with or is connected to the peripheral unit of data access arrangement DAA 111 and serves to allow the user to make phone calls without touching or holding any device, such as a headset, i.e., a hands-free mode. The peripheral unit of data access arrangement DAA 111 performs all the interface, amplification and correlation between PSTN 112 and the speakerphone 120. The speaker used can be fully and internally incorporated to the system or can be external. The integration of an speakerphone 120, internal to system, consists of a special unit 106 which performs the necessary processing of speakerphone (noise reduction, echo cancellation, etc.), and which is connected directly to the amplifier stage 105 which belongs to the unit of data access arrangement 111 and where all these units are within the same container cabinet; the speaker 109 and microphone 110, corresponding to this special unit 106, may be the same speaker 107 and microphone 108 used by the system for the functions explained above, i.e., the functions share the same device, and this would be achieved by means of an audio mixer 130 (not shown in the Figures) for each plurality of speakers and each plurality of microphones, to allow sharing of the functions of each plurality of audio devices in a single device. An independent or external speaker telephone 120 consists of connecting, directly to the peripheral unit of data access arrangement 111, a speakerphone 120 external or outside the container cabinet, said external speakerphone consists of a special unit 106 to which a microphone 109 and speaker 110 are connected, independently to those used by the master unit 101, as shown in FIG. 1. Thus, the function of a speakerphone may be incorporated to the system of the present invention to make phone calls without using hands (hands-free) and the conversation can be made by several people without a headset.

Similarly, power levelers, also known as “dimmer”, which were mentioned above, may be integrated inside or outside the same container cabinet in order to achieve the functional versatility of the system.

As explained above, the master unit 101 can record voice commands in two ways: the former is one in which voice commands are digitally recorded from the initial configuration of the system, such as with the initial configuration of firmware setting digital samples of words or phrases to be used as voice commands. The second form is that which receives audio inputs as words or phrases to be used as voice commands, which are spoken by a user through the microphone 108, where said samples are digitized, recorded and located by the master unit 101 in the memory thereof, and where the user is informed by audible signals through the speaker 107 about the location where the command is stored. The way in which the voice commands are recorded and located depends on the initial configuration of firmware which will be explained below. All commands are stored or recorded in a specified destination or location such that later, whenever the master unit 101 via the microphone 108 listens to an audio input substantially similar to the previously recorded voice command, assigns a coordinate based on the type of voice command (the types of voice commands will be explained below) and at its location. Each coordinate points to a specific operation, i.e., each memory location represents an operation. Thus, the operations are invoked and, once said operation is known, the master unit sends signals to the peripheral units responsible for the task to be performed. In the same manner, through visual means (not shown in the Figures) and/or sound 107, the type of operation being performed is indicated. The system can recognize and operate with the voices of each of a plurality of users who know the vocabulary or all recorded commands from the configuration of the system firmware, or who have recorded said commands with their voice through the microphone 108.

On the other hand, in order to reduce the amount of errors caused by false detections that commonly occur in the voice control systems existing in the prior art, a method for controlling the operation of the system was devised, which is based on hierarchical sequences of voice commands, where a great functionality and versatility is obtained with each voice command. For a better understanding of the method and way in which the system works, in the present description a hierarchical level and/or a name will be assigned to each type of command, however, one skilled in the art will appreciate that said allocation is not intended in any way to limit the scope of the present invention and it is merely intended to allow a complete understanding thereof.

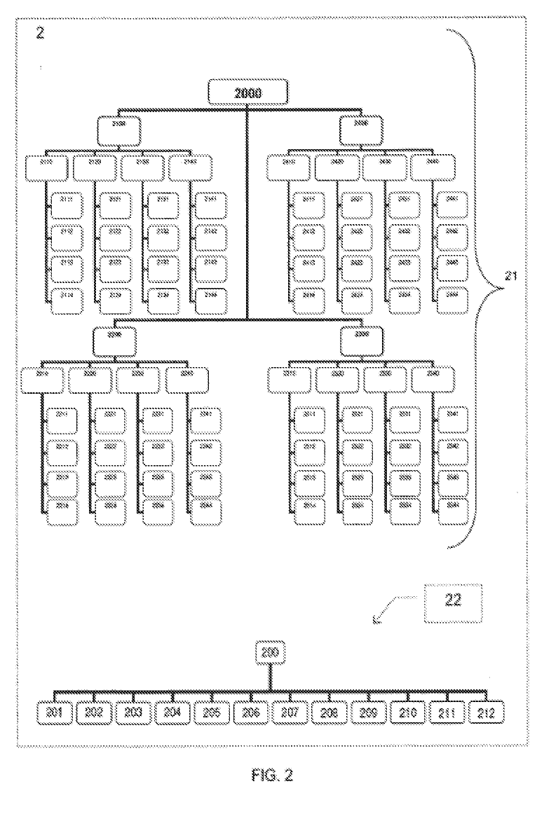

FIG. 2 shows the manner in which the voice commands can be grouped for different modes of operation (which will be explained below) that the system of the present invention can have for each of a plurality of users, i.e., may have the same amount of these diagrams as the number of users in the system.

Said operating modes define the manner in which the voice commands should be detected to invoke or request an operation. In a first mode of operation, the system operates based on structured commands in sequence, so they will be termed as Sequential Commands 21. In the second mode of operation, the system operates based on commands whose operation does not depend on a sequence, so they will be termed as Immediate Commands 22. Notwithstanding, the terms Sequential Commands and Immediate Commands are not intended in any way to limit the scope of the present invention, since said terms are intended merely to clarify the description of the manner of operating the system in accordance with the present invention. The system can work either in the first mode of operation, in the second mode of operation or in a combination of both modes of operation, depending on system configuration.

As mentioned above, in the first mode of operation, the system works using Sequential Commands 21, so that the way of operation is based on hierarchical sequences of these commands where, once initiated a sequence upon detection of voice command with the highest hierarchical level, the system waits for a definite time to hear a subsequent voice command, i.e., of a lower hierarchy (which will be explained in detail below) and corresponding to the same sequence as the command previously mentioned, so that upon completion of the sequence to be said, the system performs the corresponding operation.

In contrast, when the system is working using Immediate Commands 22, i.e., in the second mode of operation, once detected either of these commands, then the operation invoked by said command is performed without the system waiting for another command, i.e., it does not depend on a hierarchical sequence. Also, the diagrams of the Sequential Commands 21 and Immediate Commands 22, in addition to represent the way in which said commands should be structured to be told by the user in order to perform operations, also represent the way in which the plurality of commands are grouped in the memory of microcontroller of the master unit 101. However, one skilled in the art will note that the number of commands shown in the diagrams of Sequential Commands 21 and Immediate Commands 22 can vary without affecting the operation of the present invention. In the case of Sequential Commands 21, depending on the location in which every command was recorded (since the user is informed about the location where samples of words or phrases were recorded either during initial configuration or during the record of said words or phrases by the user, as explained above), is as a hierarchical value will be given to each voice commands which determines the sequence of commands that must be recognized by the system to perform various operations. In order to facilitate the understanding of the hierarchical structure of the Sequential Commands and as shown in FIG. 2, the voice Sequential Commands 21 are composed of: Cardinal Command 2000, Main Commands 2100, 2200, 2300, 2400, Secondary Commands 2110, 2120, 2130, 2140, 2210, 2220, 2230, 2240, 2310, 2320, 2330, 2340, 2410, 2420, 2430, 2440 and Extra Commands 2111, 2112, 2113, 2114, 2121, 2122, 2123, 2124, 2131, 2132, 2133, 2134, 2141, 2142, 2143, 2144, 2211, 2212, 2213, 2214, 2221, 2222, 2223, 2224, 2231, 2232, 2233, 2234, 2241, 2242, 2243, 2244, 2311, 2312, 2313, 2314, 2321, 2322, 2323, 2324, 2331, 2332, 2333, 2334, 2341, 2342, 2343, 2344, 2411, 2412, 2413, 2414, 2421, 2422, 2423, 2424, 2431, 2432, 2433, 2434, 2441, 2442, 2443, 2444.

The complete hierarchical sequence of voice Sequential Commands follows the pattern:

### Cardinal->Main->Secondary->Extra

Where the Cardinal Command 2000 has the greater hierarchical value and, although the diagram of Sequential Commands 21 only shows a single Cardinal Command, since the diagram of Sequential Commands 21 and diagram of Immediate Commands 22 represent the totality of commands that each user can have, then there may be as many of these diagrams as the number of users in the system, so it may be a plurality of Cardinal Commands that each will mark the start of their respective hierarchical sequences of voice commands. Extra Command has the lowest hierarchical value. However, although the sequence must follow the above-mentioned pattern so that the system performs an operation, the pattern can be of shorter lengths, i.e., operations can be performed using sequences of different lengths such as, for example:

### Cardinal->Main->Secondary

or

### Cardinal->Main

In other words, in order that the system of the present application performs some operation being in the first mode of operation where uses Sequential Commands, then it must recognize any sequence of voice commands spoken by the user according to the grouping structure of Sequential Commands 21, regardless of the length of the sequence, so that each of these sequences may represent some operation.

A more detailed manner of how the sequences of Sequential Commands are structured is shown below:

First, Cardinal Command 2000, then a Main Command, either 2100, 2200, 2300 or 2400 that is related to the Cardinal Command previously said according to the diagram of Sequential Commands 21, subsequently a Secondary Command either 2110, 2120, 2130, 2140; 2210, 2220, 2230, 2240, 2310, 2320, 2330, 2340, 2410, 2420, 2430 or 2440 that is related to the Main Command previously said according to the diagram of Sequential Commands 21 and an Extra Command 2111, 2112, 2113, 2114, 2121, 2122, 2123, 2124, 2131, 2132, 2133, 2134, 2141, 2142, 2143, 2144, 2211, 2212, 2213, 2214, 2221, 2222, 2223, 2224, 2231, 2232, 2233, 2234, 2241, 2242, 2243, 2244, 2311, 2312, 2313, 2314, 2321, 2322, 2323, 2324, 2331, 2332, 2333, 2334, 2341, 2342, 2343, 2344, 2411, 2412, 2413, 2414, 2421, 2422, 2423, 2424, 2431, 2432, 2433, 2434, 2441, 2442, 2443 or 2444 that is related to the Secondary Command previously said according to the diagram of Sequential Commands 21. However, one skilled in the art will note that the number of commands contained in each hierarchical level can vary without limiting the scope of the present invention.

Moreover, with respect to the second operating mode, the voice Immediate Commands 22 do not operate in a hierarchical manner as the voice Sequential Commands 21, since this set of commands can perform operations without the need of a hierarchical sequence, i.e., operations related to said Immediate Commands can be performed, which will be carried out by the system after detecting the corresponding voice command without the need for the system to wait for some other command. As a preferred embodiment, the use of this mode of operation is carried out when the operations to be performed are of a type that specifically require this mode of operation with Immediate Commands and not the mode of operation with Sequential Commands, such as, for example, to structure a phone number to make a call, where it is required that each operation, such as storing each digit of the telephone number in temporary memory, is made after detection of the command representing said operation, and out of a sequence which, in this case, would exhaust many of the resources of the master unit 101, since large amounts of memory are required for this purpose.

As stated above, the voice Immediate Commands 22 does not require a hierarchical sequence to perform some operation, i.e., at the moment when the system detects one of these commands, it will perform the operation associated with that command. Once the device is in operation mode with Immediate Commands, the system will recognize the voice Immediate Commands, i.e., a user can say any corresponding Immediate Command and, if the system detects it, the device will perform the operation that belongs or is related to said command, out of a hierarchical sequence. FIG. 2 shows a diagram of orders that describes the structure of the voice Immediate Commands 22 and the way in which they are grouped. Said diagram shows the plurality of Immediate Commands 201, 202, 203, 204, 205, 206, 207, 208, 209, 210, 211, 212 where each command can perform an operation and wherein one skilled in the art will note that the amount of Immediate Commands may vary without limiting the scope of the present invention. Also, said diagram of Immediate Commands 22 shows the Trigger Command (trigger) 200, which is a voice command whose function is, when the system operates by default in the second mode of operation (with Immediate Commands), to avoid false detections.

The system of the present invention has the ability to switch between the modes of operation mentioned above.

If the system is working in the first mode of operation with Sequential Commands 21 and it is desired to change to the second mode of operation with Immediate Commands 22, this can be done by invoking the Trigger Command (trigger) 200 which, in addition to the function of avoiding false detections, can be linked from the initial configuration with any Sequential Command, so that by invoking this Sequential Command the operation mode based on Immediate Commands will be initiated.

Trigger Command 200 can be assigned to any Sequential Command, as explained above, i.e., the system can be configured so that, for example, the operation of an Extra Command is related to the Trigger Command to change the mode of operation, so each time said Extra Command is invoked, and since it was assigned the function of the Trigger Command, its operation will be to initialize the operating mode with the voice Immediate Commands. The allocation of this function is performed in a previous configuration. Similarly, to an Immediate Command can be assigned the operation of changing the mode of operation such that the system works with Sequential Commands, and already explained above.

Any voice command or command sequence, by saying correctly by the user, has the ability to perform some operation.

In order to perform an operation by the system, depending on the operating mode in which it is, either using either Sequential or Immediate Commands, the user must provide the audio inputs, such as words or phrases that match a command or sequence of commands (following the hierarchical order) respecting the structure in which they are grouped according to the diagrams of orders 2. Each time a command or command sequence is detected, the system will inform the user through audible and/or visible signals 107.

FIG. 2 shows the manner in which the diagram of orders 2 is structured, such that the commands are said by each of a plurality of users and perform operations. This diagram also represents the order in which the words or phrases are recorded in memory as entered by the user or previously from the firmware; this diagram of orders 2 is the most representative part of the functioning of the system that is closely related to the method of operation that will be explained below. For example, in order that the user causes that the system performs the operation in 2233, such as, for example, turning on the light in the garden, the user must say, as a sequence, the commands recorded in the following locations:

### CARDINAL 2000→MAIN 2200→SECONDARY 2230→EXTRA 2233

In other words, to perform the operation that is in the location 2233, the user must say correctly and orderly the sequence of the words that were recorded at locations CARDINAL 2000, MAIN 2200, SECONDARY 2230 and EXTRA 2233, respectively. Each time the user says correctly each word or phrase, the system will inform the user by means of a visible and/or audible signal 107.

Similarly, and as another example, in order that a user causes the system performs the operation located at 203 belonging to the Immediate Commands, then first the system must be in operation mode with Immediate Commands where, if the user says correctly the Immediate Command 203, then the system will perform the operation belonging to said command, such as to record number “3” in temporary memory to structure a phone number and/or send information via serial communication port 113 (which will be explained below) to activate a device of other technology, etc. It is noteworthy that the diagram of orders 2 shows all voice commands that can be detected by the system by an user, i.e., any other user would have the same diagram of orders with the same operations and the only change would be the used words or commands, i.e., each user can have a different vocabulary, however, the system follows the pattern shown in the diagrams of FIG. 2. As an example, a user may have been the word “garden” recorded in the location 2233 (explained above), while another user may have the word “outside” recorded in the same location 2233.

The diagram of orders 2 is the pattern to be followed to structure command sequences, likewise, it represents the way in which each command is placed in memory, and also shows the location of each operation to be performed in order to carry out it after detecting the corresponding command or command sequence. Both types of orders or commands (Sequential and Immediate) may follow the same methods of recording, either where the user says the desired word or from the initial configuration of firmware (mentioned above).

Each voice order has a function, either to invoke directly an operation or to allow the detection of another group or another hierarchical level of voice order or commands. When the system is running by listening to audio inputs by the user to detect a corresponding voice command, the system compares this input with the corresponding commands that are already recorded and, based on a tolerance level configurable by the user, the system accepts or rejects the sound input, so that if that sound input is accepted, the system advances to the next level of the hierarchical sequence, i.e., to a lower hierarchical level (except in the Immediate Commands where there it does not operate through hierarchies), and also records the location of the command which the sound input was compared with and accepted to determine the operation that could be executed or to meet the group of commands that the user can say later to be detected. The operations that can be performed have been explained above, which depend on the different peripherals units, as well as the serial communication port, where each of these operations is related, from the initial configuration of firmware, to any voice command, either Sequential Command or Immediate Command, according to the diagrams 2, so that, when these commands are detected, the corresponding operations will be performed.

The operations that performs the system of the present invention may be assigned to any memory location following the pattern which the Sequential Commands 21 and voice Immediate Commands 22 are grouped with. In the case of Sequential Commands and as a preferred embodiment, it is preferred to group each type of operation with certain similarities in each group of Sequential Commands, such as, for example, the operations that the system performs due to general output peripheral unit 103 (where each independent output can be an operation) can be assigned within the Secondary Command 2130 and, as a product of its branching, result in the activation or deactivation of the first output by detecting the Extra Command 2131, then, of the following output by detecting the Extra Command 2132, then, of the following output upon location of Extra Command 2133, and of the following output in the Extra Command 2134; likewise, by invoking the same Secondary Command 2130, the system performs the group operation of activating or deactivating all outputs of the general output peripheral unit 103, which are within or are the product of the branching of said Secondary Command according to the structure of Sequential Commands 21. It is noteworthy that this is an example where one skilled in the art will appreciate that the location of each operation can be different without affecting the operation of the system of the present invention.

At this point, all operations performed by the system are actions that take a particular time to be carried out and, once the operation concludes, the system continues to work on other steps. A special type of operation, no mentioned above, are the operations that require a voice stop, which will be termed as continuous operations or operations with a continuing nature. When these operations are invoked, they carry out its operation in a continuous and indefinite manner, until they are stopped upon detection of a corresponding voice command, which will be termed as Stop Command, and each of the plurality of users can have one of these Stop Commands. These Stop Commands are recorded in the same way all other commands are recorded, i.e., from the initial configuration of firmware or when the user, through the microphone 108, says the word or phrase that will act as the Stop Command, and the system will collect a representative sample and assign it to a specific memory location for the stop operation. This location is not shown in FIG. 2. The system can be previously configured to select which operation is desired as an operation with a continuing nature. For example, if the system is configured so that the operation invoked by the Extra Command 2424 changes a television channel by increasing it and, in addition, is configured so that the operation becomes of a continuing nature, or be stopped by the Stop Command, then by invoking or requesting said operation upon detection of the corresponding command, it will start and will continue executing, i.e., the system will change the television channel increasing it in a continuous and indefinite manner, until the system detects the Stop Command. In the same manner, in the operations of the general output peripheral unit 103 where, furthermore, power levelers are integrated as explained above, the Stop Command is required to stop the operation of said power leveler, so that the level will be adjusted in the point where the user decides to stop the operation by saying the word representing the Stop Command.

The serial communication port 113 is a unit directly connected to the master unit 101 and serves to allow communication between the master unit and a microcontroller, a computer and/or a peripheral unit, etc. It also provides compatibility with other technologies that use the same communication standard, which can be the standard RS232. FIG. 5 shows an example of communication with other technologies 500. These compatible technologies can be Zigbee, UPB, X10, Insteon, etc. where, in addition to the serial communication port 113, an interface 501 is needed to perform the role of link or translator between the port 113 (which in turn is connected to the master unit 101) and the various devices within the network of each technology, such as, for example, the device 510 which may be a dry contact or a power leveler, and where it can be wired or wirelessly connected to the communication network. Said interface 501 will be directly connected to the serial communication port 113 and said connection can be wired or wirelessly connected. Since these technologies work through addresses, where each device within their network has an address that identifies it, the way in which operations are conducted via the serial communication port is through configuration of the system of the present invention, to transmit all the information and addresses needed to perform the corresponding function, and this information is sent through port 113 after being invoked by any voice order or command. For example, for compatibility with technology X10, the serial communication port 113 would have a direct connection to any interface X10, such as module TW523 of such technology X10, that is capable of translating the transmitted codes (under a standard) of the master unit 101 to codes compatible with X10, and the information that would be received through the network X10 be compatible with the standard of master unit 101. For example, in the location 2313 of FIG. 2, which also represents an operation, the address of device 03 or Key code 03 of technology X10 can be assigned, thereby, on every occasion that said operation is invoked, the system sends the order “ON” to said device if it is turned off, or the order “OFF” if it is turned on, and the master unit 101 will know the status of said device 03 since communication between technology X10 and the master unit 101 is bidirectional. The address “Home code”, necessary in X10, can be previously configured. Also, in addition to operations on and/or off, ON/OFF, operations of power leveling or dimming/brightening can be assigned, which require the model of continuous operation or continuing nature operation, wherein the information necessary to reduce or increase the power level in the circuit will be constantly and indefinitely transmitted, until a Stop Command stops the operation upon detection. This power leveling can be applied to any building lighting, to control light levels. Likewise, the transmission of codes compatible with the technology can be done for a single device or a plurality of devices, by sending several codes in a single operation. In this manner, scenarios can be created through consecutive operations or macros, where a plurality of codes or key codes (based on technology X10) would be consecutively sent, and the amount of codes is configurable by the user. Also, the code AllLightsOn, which turns on or set in a status ON all devices within the network, would be assigned to an operation of the system, such as, for example, 2310, using Sequential Commands, or 212, using Immediate Commands, so that each time said command is detected, the information is sent and the operation is performed.

For easy communication with the user, the initial operation of the system of the present invention is based on sound menus that can be selected using manual inputs 116, such as any button or touch screen. In each menu, different configurations are performed, such as the option “Record commands” that allows the user to enter words or phrases desired to invoke operations if this type of record (explained above) is matched. Another menu option is “Creation of scenarios and input of infrared codes”, and this option allows the user to change a normal operation to an operation of a continuing nature, as well to input and store the infrared codes to be used by the system. Within the master unit 101 all the menu options of the system are programmed, which allow for the user, installer and/or operator, to configure and operate the system through manual inputs 116 that are directly connected to the master unit 101, and which may be buttons, touch-based screens, displays, etc. The menu options of the system can be, for example, “Adjust level” which adjusts the tolerance level to listen to commands, whether Sequential or Immediate; “Record commands” where the user inputs the voice commands through the microphone if this record form corresponds; “Create scenarios and input infrared codes” where scenarios are created and infrared codes recorded to control equipment such as audio and video; “Delete commands” where the commands that were recorded through the microphone are deleted if they were not recorded properly or if they are to be changed; as well as the function “Listen” main option, where the system enters in operation mode with Sequential or Immediate Commands, depending on configuration.

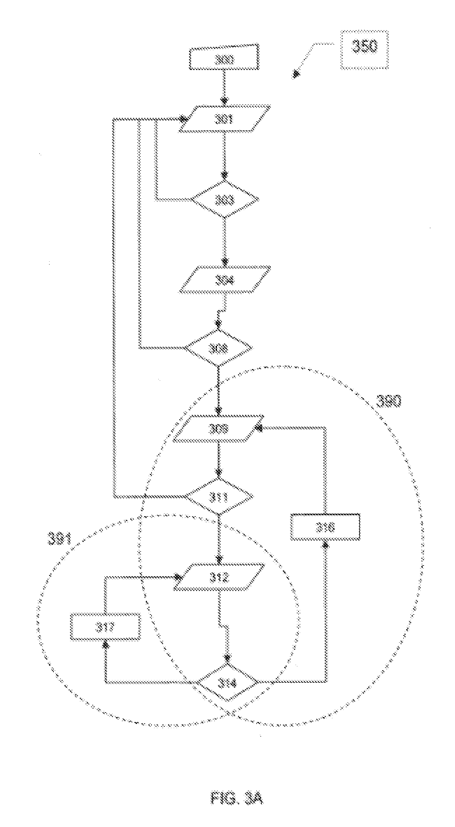

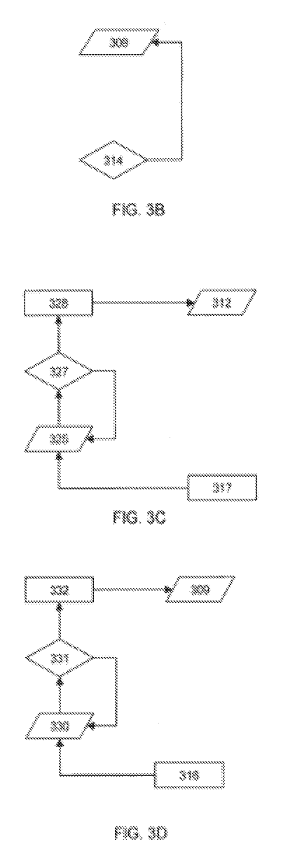

FIG. 3A shows, in a flow chart 350, the method of operation of the system 100 in its operating mode from voice Sequential Orders or Commands, once said commands have been recorded and located in memory, where the operating mode of the system is entered at step 300, based on Sequential Commands. The input can be performed through manual inputs 116 (setting up the system from firmware) or through an operation invoked by an Immediate Command.

At step 301 a hierarchical sequence initiates, in which the system waits and listens on the environment through the microphone 108 and indefinitely through any sound input, such as a word or phrase spoken by a user, such that when the system detects said audio input at step 303, compares it to the voice Sequential Commands previously recorded within the top hierarchical level which, in this case, is the Cardinal Commands, to make the decision to accept or discard said sound input, where the system accepts those sounds that are substantially similar by having a high level of similarity to any of the previously recorded Cardinal Commands; said level of similarity is previously configured and will be termed as tolerance level where, if sound input exceeds the tolerance level, then said input is accepted by the system. This tolerance level is used in all steps where the system listens for a voice command, such that, if in this step 303 the audio input detected by the system does not exceed this tolerance level when compared with each of the plurality of Cardinal Commands, the system rejects said sound input and returns to step 301, where it returns to the wait and listen status, to detect sound inputs, until the system detects an input exceeding the tolerance level as compared with any of the Cardinal Commands.

If, at step 303, any sound input detected by the system match by exceeding the tolerance level when compared with any of the previously recorded Cardinal Commands, the system accepts said sound input and advances to the next level of the hierarchical sequence (a lower hierarchical level) where, at step 304, the system waits and listens on the environment through the microphone 108 and for a pre-established period, for any sound input, such as a word or phrase spoken by a user, in order to detect an input that exceeds the tolerance level as compared with any of the voice commands of the newly established hierarchical level, according to the structure of the voice Sequential Commands 21 which, in this case, is the group of Main Commands related to the newly detected Cardinal Command.

The system is in a status of listening to detect any sound input that exceeds the tolerance level when compared with a command of the Main Commands group related to the previously detected Cardinal Command, and where once the system detects any sound input at step 308, the system compares said sound input with each Main Command if the corresponding group, and the decision to accept or reject the audio input (such as words or phrases spoken by the user) is made based on the detected tolerance level. The system is configured so that the waiting time at this step is finite and previously defined, such that, if the system detects no sound input that exceeds the tolerance level when compared with each of the corresponding Main Commands within the determined period, the system restart the hierarchical sequence positioning itself at step 301 mentioned above.

If, at step 308, the sound input matches by exceeding the tolerance level when compared to a Main Command of the corresponding group within the specified period, then the system accepts said input and further advances to the next hierarchical level of the hierarchical sequence (a lower hierarchical level) where, at step 309, the system waits and listens on the environment through the microphone 108 and for a pre-established period for any sound input, such as a word or phrase spoken by a user, in order to detect an input that exceeds the tolerance level when compared with any of the voice commands of the newly established hierarchical level, according to the structure of the voice Sequential Commands 21 which, in this case, is the group of Secondary Commands related to the newly detected Main Command.

The system is in a status of listening to detect any sound input that exceeds the tolerance level when compared with some command of the group of Secondary Commands related to the previously detected Main Command, and this, in turn, is related to the last Cardinal Command detected and where, once the system detects any sound input at step 311, the system compares said sound input with each Secondary Command of the corresponding group, and the decision to accept or reject said detected audio input (such as words or phrases said by the user) is made based on the tolerance level. The system is configured such that the waiting time in this step is finite and previously defined, so that, if the system detects no sound input that exceeds the tolerance level when compared with each of the corresponding Secondary Commands within the determined period, the system restarts the hierarchical sequence positioning itself at step 301 mentioned above.

The system of the present invention can also be configured so that, when at step 311 the system accepts no any voice command that exceeds the tolerance level when compared with the Secondary Commands and returns to step 301, before returning to step 301, performs an operation in a step 310 (not shown in the Figures), exclusive for the newly detected Main Command that was active in said sequence, which was executing.

If, at step 311, the sound input matches by exceeding the tolerance level when compared to a Secondary Command from the corresponding group within the set period, then the system accepts said input and further moves to the next hierarchical level of the hierarchical sequence (a lower hierarchical level) where, at step 312, the system waits and listens on the environment through the microphone 108 and for a pre-established period, for any sound input, such as a word or phrase spoken by a user, in order to detect any input exceeding the tolerance level when compared with any of the voice commands of the newly established hierarchical level, according to the structure of the voice Sequential Commands 21 which, in this case, is the group of Extra Commands related to the newly detected Secondary Command.

The system is in a status of listening to detect any sound input that exceeds the tolerance level when compared to a command of the group of Extra Commands related to the previously detected Secondary Command which, in turn, is related to the last Main Command detected and this, in turn, is related to the last Cardinal Command detected and where, once the system detects any sound input at step 314, the system compares the sound input with each Extra Command of the corresponding group, and the decision to accept or reject the detected audio input (such as words or phrases spoken by the user) is made based on the tolerance level. The system is configured such that the waiting time in this step is finite and previously defined, so that, if the system detects no sound input which exceeds the tolerance level when compared with each of the corresponding Extra Commands within the set period at step 316, the system performs an operation exclusive for newly detected Secondary Command; in addition, the system raises a hierarchical level of the hierarchical sequence in order to position itself again at step 309, described above, where the system waits and listen for any sound input that matches to a Secondary Command related to the last Main Command detected. Thus, a first cycle is created, which will be termed as cycle of Secondary Commands 390, in which, as explained at steps 309 and 311, the system can continue to detect and accept sound inputs that match to a Secondary Command (within the corresponding group) in order to perform, in a continuous manner (i.e., without saying the hierarchical sequence from the start), operations exclusive to said group of Secondary Commands, so that, if at step 311 the system discarded all the audio inputs (which did not exceed the tolerance level) once lapsed the allowed period (as explained above), the system will break the cycle of Secondary Commands 390 to completely restart the hierarchical sequence and position itself at step 301 described above.

If, at step 314, the sound input matches by exceeding the tolerance level when compared with an Extra Command of the corresponding group within the specified period, then the system accepts said input and, in addition, at step 317, performs an operation exclusive for the newly detected Extra Command; the system also maintains the same hierarchical level of the hierarchical sequence to position itself again at step 312 described above, where the system waits and listens for any sound input that matches an Extra Command related to the last Secondary Command detected. Thus, another cycle is created, which will be termed as cycle of Extra Commands 391, in which, as explained at steps 312 and 314, the system can continue to detect and accept sound inputs that match to an Extra Command (within the corresponding group) in order to perform, in a continuous manner (i.e., without saying the hierarchical sequence from the start), operations exclusive to said group of Extra Commands, so that, if at step 314 the system discarded all the audio inputs (which did not exceed the tolerance level) once lapsed the allowed period (as explained above), the system will break the cycle of Extra Commands 391 by returning to a hierarchical level of the hierarchical sequence and position again at step 309 described above.

A particular embodiment after step 314, where the cycle of Extra Commands 391 is just broken, is shown in FIG. 3B, where the operation of step 316 is not carried out, i.e., the system is positioned at step 309 and then directly at step 314.

A particular embodiment of the steps 301 and 304 is that if during the execution of said steps an interruption or input signal is detected through a channel of the master unit 101, such as a telephone call through the peripheral unit DAA 111, at step 307 (not shown in the Figures) an operation, e.g., answering the phone call, will be performed, and then the hierarchical sequence will be restarted and the system will return to step 301 described above.

Another particular embodiment after the operation performed at step 317 is shown in FIG. 3C where the system was configured so that the operation was continuous in nature and needed a Stop Command to stop, and where, at step 325, the system waits and listens on the environment through the microphone 108 and a indefinitely for any sound input, such as a word or phrase spoken by a user, so that, when the system detects said audio input, at step 327, compares it with the voice commands previously recorded as Stop Commands, and the decision to accept or reject said detected audio input (such as words or phrases spoken by the user) is made based on the tolerance level, so that if at this step 327 the sound input detected by the system does not exceed this tolerance level when compared with the Stop Commands, the system rejects said sound input and returns to step 325 where it returns to the status of wait and listen for the sound input detection until the system detects any input exceeding the tolerance level when compared with any of the Stop Commands. If, at step 327, any sound input detected by the system matches by exceeding the tolerance level when compared with any of the previously recorded Stop Commands, the system accepts said sound input and also, at step 328, stops the operation being performed (of a continuing nature) and then positions at the step 312 described above.

Another particular embodiment after the operation performed at step 316 is shown in FIG. 3D where the system was configured so that the operation was continuous in nature and needed a Stop Command to stop, and where, at step 330, the system waits and listens on the environment through the microphone 108 and a indefinitely for any sound input, such as a word or phrase spoken by a user, so that, when the system detects said audio input, at step 331, compares it with the voice commands previously recorded as Stop Commands, and the decision to accept or reject said detected audio input (such as words or phrases spoken by the user) is made based on the tolerance level, so that if at this step 331 the sound input detected by the system does not exceed this tolerance level when compared with the Stop Commands, the system rejects said sound input and returns to step 330 where it returns to the status of wait and listen for the sound input detection until the system detects any input exceeding the tolerance level when compared with any of the Stop Commands. If, at step 331, any sound input detected by the system matches by exceeding the tolerance level when compared with any of the previously recorded Stop Commands, the system accepts said sound input and also, at step 332, stops the operation being performed (of a continuing nature) and then positions at the step 309 described above.

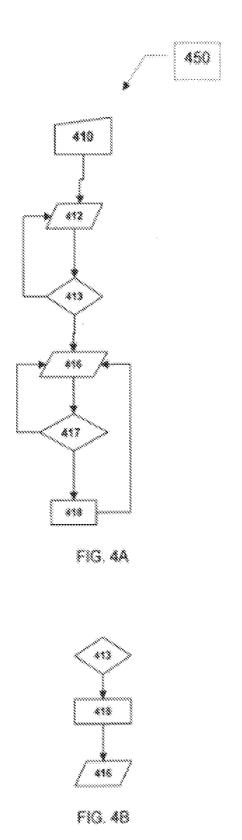

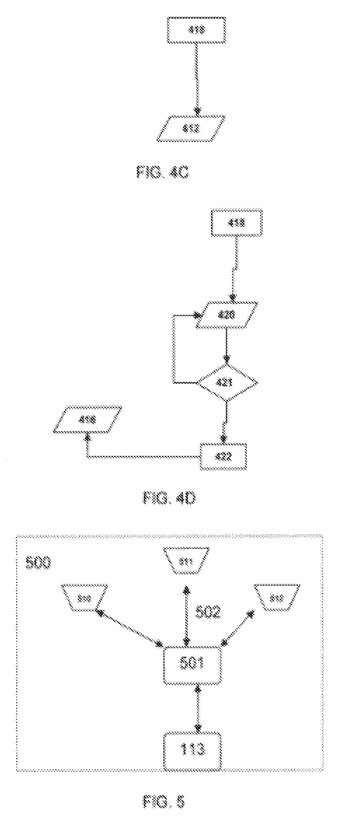

FIG. 4A shows, in a flow chart 450, the method of operation of the system 100 in its operating mode from voice Immediate Orders or Commands, once said commands have been recorded and located in memory.

At step 410, the operating mode of the system is entered based on Immediate Commands, and the entry can be done through manual inputs 116 (setting up the system from firmware) or through an operation invoked by a Sequential Command so that, at step 412, the system detects any sound input via microphone 108 such that, at step 413, said sound input is compared to Trigger Command (described above) and the decision to accept or reject the detected sound input (such as words or phrases spoken by a user) is made by the system based on the tolerance level, so that, if the system detects no sound input that exceeds the tolerance level when compared with the corresponding Trigger Command, it returns to step 412.

If, at step 413, the sound input matches by exceeding the tolerance level when compared with the Trigger Command and/or with a Sequential Command that is related to Trigger Command (described above), then the system accepts said input, so that, at step 416, the system waits and listens on the environment through the microphone 108 and indefinitely for any audio input, such as a word or phrase spoken by a user, such that when the system detects said audio input, at step 417 said audio input is compared with any of the corresponding voice Immediate Commands according to the structure of the voice Immediate Commands 22 of FIG. 2, and the decision to accept or reject the detected audio inputs (such as words or phrases spoken by a user) is made by the system based on the tolerance level so that, if the system detects no sound input that exceeds the tolerance level when compared with each of the corresponding Immediate Commands, returns to step 416.

If, at step 417, the sound input matches by exceeding the tolerance level when compared to an Immediate Command, then, at step 418, the system performs the operation exclusive for said command to position itself again at step 416 described above.

Furthermore, a particular embodiment after step 413, where the system accepts or rejects said input sound when compared to the Trigger Command, is shown in FIG. 4B, where the system, at step 415, performs an operation exclusive for Trigger Command (in addition to the operation of changing the operating mode) and then positions at the step 416 described above. Said operation can be performed depending upon the previous system configuration.

In addition, a particular embodiment after the operation performed at step 418 is shown in FIG. 4C, wherein said operation positions the system at step 412. This is done to reduce the risk of operations performed because of false detections.

Another particular embodiment after the operation performed at step 418 is shown in FIG. 4D where the system was configured so that the operation was continuous in nature and needed a Stop Command to stop, and where, at step 420, the system waits and listens on the environment through the microphone 108 and a indefinitely for any sound input, such as a word or phrase spoken by a user, so that, when the system detects said audio input, at step 421, compares it with the voice commands previously recorded as Stop Commands, and the decision to accept or reject said detected audio input (such as words or phrases spoken by the user) is made based on the tolerance level, so that if at this step 421 the sound input detected by the system does not exceed this tolerance level when compared with the Stop Commands, the system rejects said sound input and returns to step 420 where it returns to the status of wait and listen for the sound input detection until the system detects any input exceeding the tolerance level when compared with any of the Stop Commands. If, at step 421, any sound input detected by the system matches by exceeding the tolerance level when compared with any of the previously recorded Stop Commands, the system accepts said sound input and also, at step 422, stops the operation being performed (of a continuing nature) and then positions at the step 416 described above.

1. A standalone voice-controlled system for controlling a plurality of kinds of operations of a plurality of services found in home and office; and for communicating with home control and automation technologies comprising:
a) a master unit that synthesizes, processes and stores voice inputs to emit and/or receive pulses and/or information via a plurality of channels to perform different operations;
b) a microphone to receive sound inputs for processing by the master unit, wherein said microphone is connected to the master unit;
c) a speaker connected to the master unit for interaction of the system with the user through audible signals;
d) an infrared peripheral unit connected to the master unit for receiving and sending infrared codes to control equipment compatible with infrared protocols;
e) an general output peripheral unit consisting of an amplifier stage for each of the at least one of the plurality of channels of master unit, allowing the connection to the outputs of this unit, of different electrical and/or electronic devices;
f) a telephonic unit or peripheral unit of data access arrangement connected to the master unit for interaction with the telephonic network; and
g) a serial communication port connected to the master unit for communicating with home control and automation technologies by allowing transmission and/or receipt of information under a serial communication standard

2. The system according to claim 1, further characterized in that the general output peripheral unit permits the control of actuators upon detection of a corresponding voice command.

3. The system according to claim 2, further characterized in that the actuators are implemented in pumps, valves and motors.

4. The system according to claim 1, further characterized in that the actuators can be activated/deactivated for a continuous and indefinite time and this activation/deactivation will stop upon detection of a corresponding voice command.

5. The system according to claim 4, wherein the system controls the fully or partially opening and/or closing of windows, doors, shutters and/or curtains.

6. The system according to claim 1, further characterized in that at least one output of the general output peripheral unit has connected an electric power leveler to level the power of lights, motors and electronic circuits.

7. The system according to claim 6, further characterized in that the leveler can increase/decrease (leveling) the electric power of its corresponding output for a continuous and indefinite time and this leveling will stop upon detection of a corresponding voice command.

8. The system according to claim 1, further characterized in that the infrared peripheral unit can transmit a plurality of infrared codes one or more times, or transmit an individual infrared code one or more times, for a continuous and indefinite time and this transmission will stop upon detection of a corresponding voice command.

9. The system according to claim 8, further characterized in that the system can tune the station/channel of a audio/video equipment and/or change the volume of an audio equipment for a continuous and indefinite time and this tune/change will stop upon detection of a corresponding voice command.

10. The system according to claim 1, further characterized in that the serial communication port can transmit to a home control and automation technology a plurality of serial commands one or more times, an individual serial command one or more times, or one sole serial command; in order to: level the electric power, tune a station/channel, change the volume and/or activate/deactivate an actuator of their corresponding devices,
for a continuous and indefinite time and these operations will stop upon detection of a corresponding voice command.

11. The system according to claim 1, further characterized in that a speakerphone is connected to the telephonic unit for conversations for at least one user and without a headset.

12. The system according to claim 1, further characterized in that the system is contained in a single cabinet.

13. The system according to claim 12, further characterized in that the speakerphone is internally integrated to the container cabinet of the system.

14. The system according to claim 12, further characterized in that the speakerphone is externally integrated to the container cabinet of the system.

15. The system according to claim 12, further characterized in that each power leveler may be integrated within or outside the container cabinet of the system.

16. The system according to claim 1, further characterized in that the system is further configured to perform operations of a continuing nature.

17. The system according to claim 16, further characterized in that each operation of continuing nature is performed in a continuous and indefinite manner, and will only stop upon detection of a corresponding voice command.

18. The system according to claim 1, further characterized in that the system is further configured to perform, through the infrared peripheral unit, a variable plurality of consecutive infrared operations that will be termed as macros upon detection of a corresponding voice command.

19. The system according to claim 18, further characterized in that the operation of macros can be stopped at any time upon detection of a corresponding voice command.

20. The system according to claim 1, further characterized in that the user can connect to or disconnect from the telephone network at any time upon detection of a corresponding voice command.

21. The system according to claim 1, further characterized in that it includes an external interface of other technology for communication and control of devices of other technologies, such as X10, Zigbee, Insteon etc. upon detection of a corresponding voice command.

22. The system according to claim 1, further characterized in that the communication between technologies is performed under the standard RS232.

23. The system according to claim 1, further characterized in that the microphone and/or speaker are wireless.

24. The system according to claim 1, further characterized in that the microphone and/or speaker are wired.

25. A method of operation of a standalone voice-controlled system which reduces the risk of error due to false detections because of its hierarchical structure and facilitates the performance of continuous voice operations, wherein the method is based on hierarchical sequences of variable lengths of voice inputs said by a user, with the ability to perform operations through a infrared peripheral unit, a general output peripheral unit, a telephonic unit and/or a serial communication port, wherein each hierarchical level may be comprised of one or a plurality of groups of commands and, further, any possible sequence represents an operation and each operation can be an operation of continuous nature, wherein cycles are created to provide control to this operations which need a continuous control and an indefinite time for being stopped by a voice input, the method comprising the steps of:
a) Starting a hierarchical sequence in which the system waits and listens indefinitely in the environment through the microphone for any sound input, such as words or phrases by a user, to detect any entry matching by exceeding the level of tolerance when compared to commands with the highest hierarchical level, which in this case are the Cardinal Commands, and wherein if the sound input does not match any Cardinal Command, the system will remain in step a) and continue in this process to continue listening indefinitely to detect a sound input that matches a Cardinal Command, and wherein, if the system detects a sound input that matches by exceeding the tolerance level when compared to any Cardinal Command, the system advances to next hierarchical level comprising the Main Commands related to newly detected Command Cardinal;
b) Where the system waits and listens on the environment, through a microphone and for a pre-established period for any sound input, such as words or phrases by a user, to detect any input that matches by exceeding the tolerance level when compared with previously recorded commands that are within the newly established hierarchical level, which in this case are the Main Commands related to the last Cardinal Command detected, and where if the system detects no sound input that exceeds the tolerance level when compared with the Main Commands within the specified period, the hierarchical sequence restarts returning to step a), and where if the system detects an input sound that matches by exceeding the tolerance level when compared to a Main Command within the specified period, the system advances to the next hierarchical level that includes Secondary Commands related to the newly detected Main Command; c) The system waits and listens to environment, through the microphone and for a pre-established period for any sound input, such as words or phrases by a user, to detect any input that matches by exceeding the tolerance level when compared with the previously recorded commands within the newly established hierarchical level, which in this case are the Secondary Commands related to the last Main Command detected, and where if the system detects no sound input that exceeds the tolerance level when compared with Secondary Commands within the specified period, the hierarchical sequence restarts returning to step a), being able to perform an operation exclusive to said Main Command newly detected before positioning at step a), and where if the system detects a sound input that matches by exceeding the tolerance level when compared with a Secondary Command within the specified period, the system advances to the next hierarchical level comprising Extras Commands related to newly detected Secondary Command;
d) The system will waits and listens in the environment through a microphone and for a pre-established period for any sound input, such as words or phrases by a user to detect an input that matches by exceeding the tolerance level when compared with previously recorded commands that are within the newly established hierarchical level, which in this case are Extra Commands related to the last Secondary Command detected, and where if the system detects no sound input that exceeds the tolerance level when compared with the Extra Commands within the specified period, then the system performs an operation exclusive to Secondary Command newly detected, returns to a hierarchical level and positions again in step c) explained above, where the system waits and listens on the environment for a Secondary Command related to last Main Command detected, thus initiating a cycle of Secondary Commands that can only be broken by detecting no sound input that exceeds the tolerance level when compared with the Secondary Commands within the specified period. If the system detects a sound input that matches by exceeding the tolerance level when compared with an Extra Command within the specified period, the system performs an operation exclusive to Extra Command newly detected and positions again at step d) explained above, wherein the system waits and listens for any Extra Command related to last Secondary Command detected to start a cycle of Extra Commands that can only be broken by detecting no sound input that exceeds the tolerance level when compared with a Extra Command within the specified period where the system is positioned at step c) explained above.

26. The method according to claim 25, further characterized in that after the step where an Extra Command is not detected within the specified period, the system will not perform the operation exclusive to Secondary Command if it directly breaks the cycle of Extra Commands.

27. The method according to claim 25, further characterized in that, in steps where the system waits and listens on the environment through the microphone and for a specified period, for any input sound, if the system detects an interruption or input signal, such as an incoming phone call, the system can be expedite connected to the telephonic network.

28. The method according to claim 25, further characterized in that, in the step where the operation pertaining or exclusive to an Extra Command is performed, said operation is continuous, and where the system waits and listens on the environment through a microphone and indefinitely, for any sound input, such as words or phrases, to detect any input that matches by exceeding the tolerance level when compared with the words recorded as Stop Commands, where if the system detects no input sound that matches a Stop Command, then the operation will not stop (will be continued) and where if the system detects a sound input that matches by exceeding the tolerance level when compared with a Stop Command, then the operation of a continuing nature being performed automatically stops and the hierarchical level is maintained and the system is positioned again in step where waits and listens for any sound input that matches any Extra Command related to the last Secondary Command detected.

29. The method according to claim 25, further characterized in that, in the step where the operation pertaining or exclusive to a Secondary Command is performed, said operation is continuous, and where the system waits and listens on the environment through a microphone and indefinitely, for any sound input, such as words or phrases, to detect any input that matches by exceeding the tolerance level when compared with the words recorded as Stop Commands, where if the system detects no input sound that matches a Stop Command, then the operation will not stop and will be continued indefinitely, and where if the system detects a sound input that matches by exceeding the tolerance level when compared with a Stop Command, then the operation of a continuing nature being performed automatically stops and the hierarchical level is maintained and the system is positioned again in step where waits and listens for any sound input that matches any Secondary Command related to the last Main Command detected.

30. The method according to claim 25, further characterized in that if the operation is continuous the system waits and listens on the environment through a microphone and indefinitely, for any sound input, such as words or phrases, to detect any input that matches by exceeding the tolerance level when compared with the words recorded as Stop Commands, where if the system detects no input sound that matches a Stop Command, then the operation will not stop (will be continued) and where if the system detects a sound input that matches by exceeding the tolerance level when compared with a Stop Command, then the operation of a continuing nature being performed automatically stops.

31. The method according to claim 30, wherein the continuous operations can be: leveling the electric power, tuning a TV channel and/or radio station, changing the volume of audio/video equipment, turning on/off an electric/electronic circuit and transmitting to a home control and automation technology one or more serial commands.

32. A standalone fully voice-controlled telephone with a plurality of telephonic functions comprising:
a) a master unit with voice recognition capabilities which can emit and/or receive pulses and/or information via a plurality of channels to perform different operations;
b) a telephonic unit or unit of data access arrangement connected to the master unit for interaction with the telephonic network;
c) a microphone to receive sound inputs for both, processing by the master unit and communicating through the telephone line, wherein said microphone is connected to the master unit and to the telephonic unit;
d) a speaker connected to the master unit for interaction of both, the system and the telephone line, with the user through audible signals;
wherein the telephone unit is sharing elements, like the microphone and the speaker, with the voice-controlled unit in order to have a single device fully governed by voice inputs which will be said by the user for configuring and operating the functions of the telephone during or not during a telephonic conversation.

33. The voice-controlled telephone of claim 32, wherein the telephone is fully adapted to be used for people with limited mobility.

34. The voice-controlled telephone of claim 32, wherein the voice inputs said by the user can operate and/or configure the totality of functions of the telephone in order to have a fully hands-free telephone.

35. The voice-controlled telephone of claim 34, wherein the functions that can be executed by the telephone are: receiving a telephone call, making a telephone call, redialing (dialing of the last number dialed), dialing a telephone number, saving a telephone number in memory, dialing a telephone number saved in memory, informing about a telephone number saved in memory, informing about a telephone number saved in temporary memory, deleting a telephone number saved in memory, deleting a number saved in temporary memory, disconnecting from the telephone line and connecting to the telephone line.

36. A standalone voice-controlled expedited scenario system for executing a sequential plurality of domestic services called scenarios in a expedited way comprising:
a) a master unit that synthesizes, processes and stores audio inputs to emit and/or receive pulses and/or information via a plurality of channels to perform different operations;
b) a microphone to receive sound inputs for processing by the master unit, wherein said microphone is connected to the master unit;
c) a speaker connected to the master unit for interaction of the system with the user through audible signals;
d) an infrared peripheral unit connected to the master unit for receiving and sending infrared codes to control equipment compatible with infrared protocols;
e) a serial communication port connected to the master unit for interaction with home control and automation technologies by allowing transmission and/or receipt of information under a serial communication standard.
wherein the system executes a plurality of operations, like sending infrared codes to control equipment compatible and/or sending commands to control a particular home control and automation technology, as a result of a continuous listening for one or sequentially two of a plurality of voice inputs pre-defined which will be said by a user wherein the voice inputs are related to specific activities or devices in home and office.

37. The voice-controlled expedited scenario system of claim 36, wherein the voice inputs related to specific activities or devices in home and office are based on the desires and needs of the user like: Movie, Garden, Outside, Lights, All lights On, All Lights Off and others related.

38. The voice-controlled expedited scenario system of claim 36, wherein the system communicates with home control and automation technologies like Insteon, X10, Zigbee, UPB, Z-Wave and others.

39. The voice-controlled expedited scenario system of claim 36, wherein a scenario comprises a variable amount of operations of the plurality of peripheral units of the system.
